(19) United States
(12) Patent Application Publication
(10) Pub. No.: US 2020/0021989 A1
(43) Pub. Date: Jan. 16, 2020

(54) Controlling Access And Accessing A Traffic Network In A High Density Environment

(71) Applicant: CLOSE COMMS LIMITED, Newport (GB)

(72) Inventor: Christopher Smith, Llanbadoc (GB)

(21) Appl. No.: 16/470,085

(22) PCT Filed: Dec. 7, 2017
(86) PCT No.: PCT/GB2017/053687

§ 371 Date: Jun. 14, 2019

(30) Foreign Application Priority Data
Dec. 16, 2016 (GB) 1621507.1

(51) Int. Cl. H04W 12/08; H04W 76/10; H04W 48/20; H04L 12/46; H04W 28/02; H04W 12/06

(52) U.S. Cl. CPC H04W 12/08; H04W 76/10; H04W 48/20; G06F 8/60; H04W 28/0205; H04W 12/06; H04L 12/4641

(57) ABSTRACT

A method and wireless access point for controlling access to a traffic network in a high density environment, the network comprising a set of traffic network resources, and a wireless terminal for accessing such network is disclosed. The method comprises the steps of: providing at least one wireless access point; establishing a wireless link between a wireless terminal and the wireless access point; establishing an unauthenticated traffic link between the wireless terminal and the wireless access point; restricting access of the wireless terminal to the traffic network via the unauthenticated traffic link to a subset of the set of traffic network resources, wherein at least one traffic network resource is associated with an operating system of the wireless terminal; detecting the operating system of the wireless terminal using traffic communicated along the wireless link; establishing a link between the wireless terminal and the traffic network resource associated with the detected operating system; downloading a traffic network access program to the wireless terminal from the traffic network resource; executing the traffic network access program on the wireless terminal; establishing an authenticated traffic link between the wireless terminal and the wireless access point using an authentication signal generated by the network access program.

This application represents the national stage entry of PCT International Application No. PCT/GB2017/053687 filed on Dec. 7, 2017 and claims priority to GB Patent Application No. 1621507.1 filed on Dec. 16, 2016. The disclosure of each of the above-identified applications is hereby incorporated by reference as if set forth in their entirety herein.

The present disclosure relates to a method for controlling access of wireless terminals to a traffic network in a high density environment, a wireless access point for the same and to a wireless terminal for accessing such network.

Providing reliable connectivity in high-density environments like sports venues, restaurants and retail stores, is not trivial. Currently, when fans visit stadiums on a match day, to watch their team play, there is limited cellular data coverage to enable reliable Internet access, such as browsing web pages or checking messages on social media. The main reason for this is that a network infrastructure to support high density of network users in one place is not usually installed by the mobile network providers where stadiums are located. There are many technical challenges to overcome in designing a reliable network to provide controlled access to mobile device users in such environments.

A typical way of ensuring network access in commercial environments is a standard Wi-Fi® deployment. However, such deployments in large stadium environments require use of expensive distributed antenna systems (DAS). Wi-Fi® access points and cellular base stations are connected to the radio frequency (RF) distribution channel, but the data processing is still performed by the access point or base station. Conceived and developed primarily for extending cellular signals indoors where “outside-in” coverage is challenging, some 802.11 Wi-Fi features, such as multiple input/multiple output (MIMO) may not work as designed over a DAS.

It is also known to use a web application for controlling access to a Wi-Fi access point, but this often requires locking the user to a captive portal. A further problem with the captive portal is that the Wi-Fi connection is not closed when the app is not used, therefore the user can open the application, then close the application and still have full internet access, which is not desirable.

It is an object of the present disclosure to provide a technical solution to at least some of the issues outlined above and to provide an improved infrastructure for enabling controlled wireless network access to the users.

In accordance with a first aspect of the present disclosure, there is provided a method for controlling access to a traffic network in a high density environment, the traffic network comprising a set of traffic network resources, the method comprising the steps of: providing at least one wireless access point; establishing a wireless link between a wireless terminal and the wireless access point; establishing an unauthenticated traffic link between the wireless terminal and the wireless access point; restricting access of the wireless terminal to the traffic network via the unauthenticated traffic link to a subset of the set of traffic network resources, wherein at least one traffic network resource is associated with an operating system of the wireless terminal; detecting the operating system of the wireless terminal using traffic communicated along the wireless link; establishing a link between the wireless terminal and the traffic network resource associated with the detected operating system; downloading a traffic network access program to the wireless terminal from the traffic network resource; executing the traffic network access program on the wireless terminal; establishing an authenticated traffic link between the wireless terminal and the wireless access point using an authentication signal generated by the network access program.

In an embodiment, restricting traffic network access includes restricting traffic network access to selected traffic network domains, wherein at least one domain is associated with the operating system of the wireless terminal.

In an embodiment, the method includes a step of sending, from the wireless access point to the wireless terminal, an execution signal adapted to execute the network access program at the wireless terminal.

In an embodiment, the execution signal may be sent from the wireless access point to the wireless terminal via a remote authentication server.

In an embodiment, establishing an unauthenticated traffic link involves establishing a virtual local area network connection.

In an embodiment, establishing an authenticated traffic link involves setting a threshold time so that when the time passes the threshold time, the authenticated traffic link becomes closed.

In an embodiment, the authenticated traffic link between the wireless terminal and the wireless access point may be established via a remote authentication server.

In an embodiment, the method further includes sending, via the unauthenticated traffic link, a traffic signal to the wireless terminal from the wireless access point, the traffic signal being configured to indicate a location of the network access program in the traffic network resource.

In accordance with a second aspect of the present disclosure, there is provided a wireless access point for controlling access to a traffic network in a high-density environment, the traffic network comprising a set of traffic network resources, the access point comprising: a module configured to establish a wireless link between a wireless terminal and a wireless access point; an authentication module configured to establish an unauthenticated traffic link between the wireless terminal and the wireless access point and to restrict access of the wireless terminal to a subset of the set of the traffic network resources, wherein at least one traffic network resource is associated with an operating system of a wireless terminal, the network resource comprising a traffic network access program, wherein the authentication module is further configured to receive, from the wireless terminal via the unauthenticated traffic link, an authentication signal from the network access program on the wireless terminal, the signal being used to establish an authenticated traffic link between the wireless access point and the wireless terminal.

In an embodiment, the authentication module is further configured to send, when the access point uses unauthenticated traffic link, a traffic signal to the wireless terminal, the traffic signal being configured to indicate a location of the network access program in the traffic network resource. The authentication module may be further configured to restrict traffic network access to selected network domains, wherein at least one network domain is associated with the operating system of the wireless terminal. The authentication module may also be configured to send to the wireless terminal, via the unauthenticated traffic link, an execution signal adapted to execute the network access program at the wireless terminal. The unauthenticated traffic link may comprise a virtual local area network connection. In an embodiment, the access point is a multi-radio wireless access point comprising adaptive antenna array configured to generate a plurality of radio beams so that a number of simultaneous wireless links between the access point and wireless terminals can be maximised.

In an embodiment, the authentication module may be configured to send the execution signal to the wireless terminal via a remote authentication server using the unauthenticated traffic link.

In an embodiment, the authenticated traffic link between the wireless terminal and the wireless access point may be established via a remote authentication server.

In accordance with a third aspect of the present disclosure, there is provided a wireless terminal for accessing a traffic network in a high-density environment, the traffic network comprising a set of traffic network resources, the wireless terminal comprising: an operating system adapted to execute a network access program; a first interface for establishing a first wireless link between the wireless terminal and a wireless access point; a second interface for establishing a second wireless link between the wireless terminal and a beacon; a traffic link module configured to establish an unauthenticated traffic link between a wireless terminal and the wireless access point, the unauthenticated traffic link having traffic network access restricted to a subset of the wireless terminal traffic network resources, wherein at least one traffic network resource is associated with the operating system of the wireless terminal, a network access program configured to send an authentication signal to the wireless access point using the traffic link module, the signal being used to establish an authenticated traffic link between the wireless access point and the wireless terminal.

In an embodiment, the unauthenticated traffic link has traffic network access restricted to selected network domains, wherein the at least one domain is associated with the operating system of the wireless terminal.

In an embodiment, the network access program comprises a wireless access point identifier, the network access program being further configured to instruct the first wireless interface to establish a traffic link with the wireless access point identified by the wireless access point identifier. The network access program may be further configured to receive, via the second interface, location signals from the beacon for navigating the user of the terminal when the terminal is used in a high-density venue.

In an embodiment, the wireless terminal may be further configured to receive, from the wireless access point during the unauthenticated traffic link, an execution signal adapted to execute the network access program.

In an embodiment, the wireless terminal is further configured to receive, via the unauthenticated traffic link, a traffic signal from the wireless access point, the traffic signal being configured to indicate a location of the network access program in the traffic network resource. The unauthenticated traffic link may also comprise a virtual local area connection.

In an embodiment, the wireless terminal may be configured to receive the execution signal from the wireless access point via a remote authentication server.

In an embodiment, the authenticated traffic link between the wireless terminal and the wireless access point may be established via a remote authentication server.

Whilst specific embodiments have been described above, the disclosure extends to any inventive combination of features set out above or in the following description. Although illustrative embodiments are described in detail herein with reference to the accompanying drawings, it is to be understood that the disclosure is not limited to these precise embodiments.

Furthermore, it is contemplated that a particular feature described either individually or as part of an embodiment can be combined with other individually described features, or parts of other embodiments, even if the other features and embodiments make no mention of the particular feature. Thus, the disclosure extends to such specific combinations not already described.

The disclosed subject matter may be performed in various ways, and, by way of example only, embodiments thereof will now be described with reference to the accompanying drawings, in which:

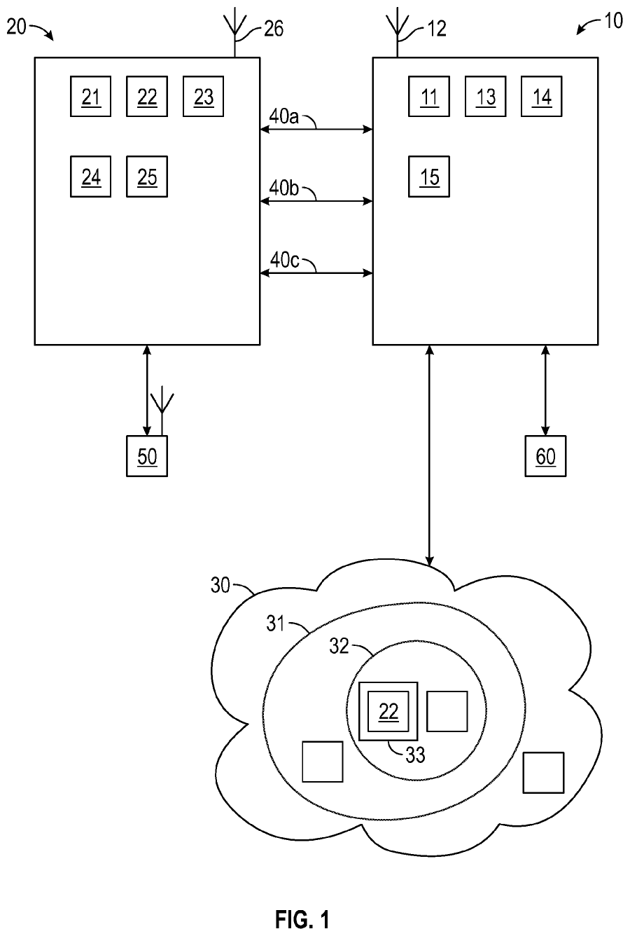

FIG. 1 is a schematic illustration of a wireless access point according to an embodiment of the present disclosure and a wireless terminal according to an embodiment of the present disclosure;

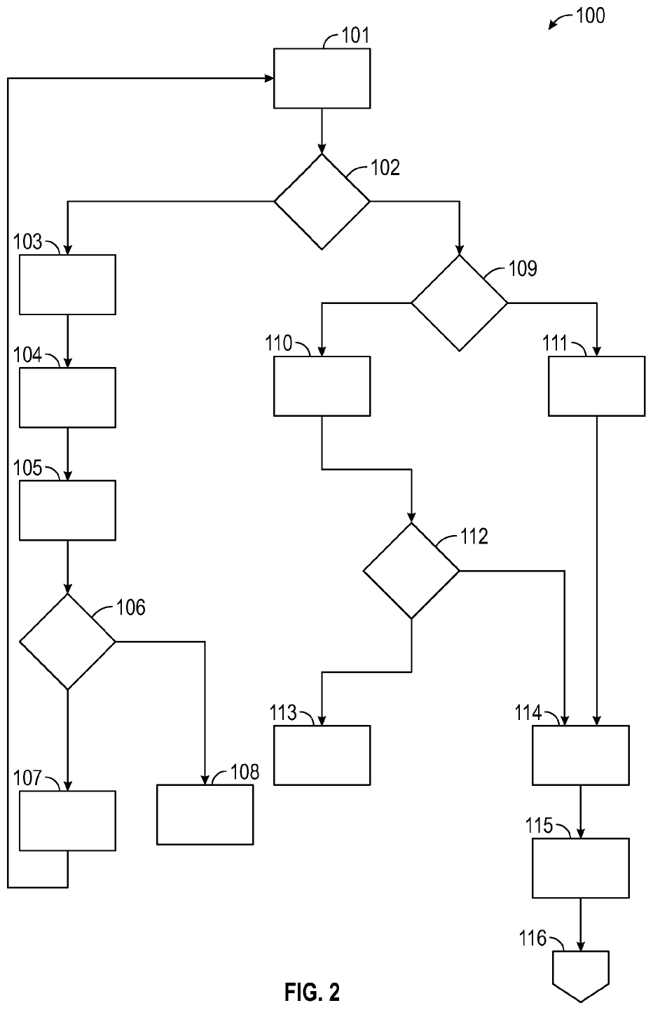

FIG. 2 is a flowchart illustrating the steps of a method according to an embodiment of the present disclosure.

Referring to FIG. 1 of the drawings, there is illustrated a wireless access point 10 according to any embodiment of the present disclosure for providing network access to a wireless terminal 20 according to an embodiment of the present disclosure. The wireless access point 10 may include a Wi-Fi router (not shown) configured to provide wireless terminal 20, such as a smartphone or tablet, with access to a Wi-Fi network, however it may also include a base station (not shown), such as a picocell or femtocell, associated with a cellular network. The access point 10 includes a module 11 configured to establish a wireless link 40a between the wireless terminal 20 and the wireless access point 10. The module 11 may be a radio module associated with an antenna 12 to broadcast or receive a wireless signal, such as IEEE 802.11 signal. In particular, the wireless access point 10 may also comprise a multi-radio wireless access point comprising an adaptive antenna array (not shown), and may be configured to implement the IEEE 802.11ac standard. This is important in situations where multiple users request network access at the same time, which requires enough radio resources to provide physical layer connection channels, so that uninterrupted network access may be ensured. The wireless access point 10 comprises a traffic network interface 13, such as Wide Area Network (WAN) interface which is used to access a set 31 of traffic network resources by the terminal 20 wirelessly connected to the wireless access point 10. The interface 13 may include, among others, a DSL interface, cellular network interface such as LTE interface or any other backbone interface. The traffic network 30 includes a set 31 of traffic network resources which may be accessed by the wireless terminals 20. Such resources may include web pages, portals, and/or databases, which are accessible via an Internet Protocol (IP) network, for example.

The wireless access point 10 is configured to control access to the traffic network 30, which is effected by embodying an authentication module 14 in the wireless access point 10. This module 14 may be realised by a software package stored in a memory (not shown) of the wireless access point 10 or as a hardware module designed to perform this function. The authentication module 14 is configured to establish an unauthenticated traffic link 40b, such as virtual local area network connection, between the wireless terminal 20 and the wireless access point 10. The unauthenticated traffic link 40b of the higher layers of the protocol stack is established when a radio connection 40a of the physical layer between the terminal 20 and the access point 10 is already in place. An exchange of packets or frames is then possible therebetween, however the authentication module 14 restricts access of the wireless terminal 20 to a subset 32 of the set 31 of the traffic network resources. This restriction may be performed by maintaining a list 15 of the accessible subset 32 of traffic network resources and comparing address metadata associated with traffic which originates at the wireless terminals 20 with whitelisted addresses. Any traffic which originates at wireless terminals 20 that is destined to traffic network resources which are not whitelisted is blocked. At least one traffic network resource 33 of the subset 32 which may be whitelisted for access by the wireless terminals 20, is associated with an operating system 21 of a wireless terminal 20. This resource 33 may comprise a web page storing multiple application programs downloadable and executable only on the wireless terminal 20 operated by a particular operating system 21. The traffic network resource 33 may also comprise resources such as computers, networks, and services grouped under an internet domain, such as www.trafficnetworkresource.com, for example, wherein the domain is intended for use only by a wireless terminal 20 operated by the particular operating system 21. The resource 33 may also be a so-called “app store” comprising ‘applications’ for Android or iOS operated wireless terminals, for example. The app store may include and enable downloading to the wireless terminal 20, a traffic network access program 22. The wireless access point 10 may store information relating to the location of the network access program 22 in the app store. This information may be embodied in a Uniform Resource Identifier (URI) or Uniform Resource Locator (URL), which is then encapsulated in a packet or frame and sent to the wireless terminal 20 so that there is no need to manually find the network access program 22 in the app store. The authentication module 14 is further configured to receive, from the wireless terminal 20 via the unauthenticated traffic link 40b, an authentication signal from the network access program 22 on the wireless terminal 20. The authentication signal may comprise a packet of data including first information identifying the wireless terminal 20, such as a MAC address and second information confirming that the network access program 22 is executed on the wireless terminal 20. This information is extracted from the packet, such as Hypertext Transfer Protocol (HTTP) packet, by the wireless access point 10, and subsequently processed to unblock the outgoing traffic from the wireless terminal 20 from which the authentication signal originated so that an authenticated traffic link 40c is established between the wireless terminal 20 and wireless access point 10 and the wireless terminal 20 is provided with an unrestricted access to the set 31 of resources in the traffic network 30.

The establishing of the unauthenticated traffic link 40b and authenticated traffic link 40c may be controlled by a remote authentication server 60. The server 60 may be communicatively coupled with the access point 10 and may act as an intermediary in an exchange of signals or messages between the wireless terminal 20 and traffic network 30 such that a general control of access to the traffic network 30 by the wireless terminal 20 may be delegated to the server 60. The server 60 may also be configured to control the exchange of the authentication signal. The skilled person will realise that the server 60 may be implemented as a software package on a variety of computing hardware, or as a standalone hardware unit. The connection between the access point 10 and server 60 is independent from any access network connection between the terminal 20 and access point 10, may be encrypted and/or substantially constantly active so that the authentication process may be effectively performed anytime needed.

It will be apparent to the skilled person that various designs of the wireless access point and modules thereof are possible and the described example should not be limited to one physical device comprising all the modules. The skilled person will be aware of alternative designs, for example involving distribution of some modules to different physical machines.

The wireless access point 10 is configured to communicate with the wireless terminal 20, which is configured to access the traffic network 30 via the wireless access point 10. The wireless terminal 20 may be a smartphone, tablet, personal digital assistant or portable computer, for example. The wireless terminal 20 is controlled by the operating system 21, such as Android or iOS, which is configured to execute operating system-specific applications on the wireless terminal 20. The wireless terminal 20 comprises a first radio interface 23, such as Wi-Fi interface configured to operate in 2.4 or 5 GHz bands and to establish a physical layer radio link 40a between the wireless terminal 20 and the access point 10, and a second radio interface 24 operating in different radio technology, such as Bluetooth® Low Energy and configured to communicate with a beacon 50, which may be positioned at various locations around the venue.

The wireless access terminal 20 further comprises a traffic link module 25, implemented in hardware or software, and configured to establish an unauthenticated traffic link 40b between the wireless terminal 20 and wireless access point 10. The wireless terminal 20 is adapted to execute the network access program 22 having a wireless access point identifier stored therein, the identifier being a service set identifier (SSID) of the access network operated by the Wi-Fi router, for example. The network access program 22, which may be installed by downloading it from the resource 33, is configured to instruct the first interface 23 to establish the wireless link 40a with the wireless access point 10 identified by the wireless access point identifier. The network access program 22 may comprise an Android or iOS application, for example, and may also receive, via the second interface 24, such as Bluetooth interface, location signals from the beacon 50 when the wireless terminal 20 is located proximate thereto. The signals are processed in the network access program 22 so that the beacon 50 is identified along with a pre-stored geographical position thereof so that a map may be generated on the wireless terminal 20 allowing the user to navigate through the venue (not shown), such as within a sports stadium, restaurant or retail store.

It will be apparent to the skilled person that various designs of the wireless terminal and modules thereof are possible and the described example should not be limiting. The skilled person will be aware of alternative designs and inherent features of the wireless terminal, such as antenna 26.

Referring now to FIG. 2 of the drawings, there is illustrated a method 100 according to any embodiment of the present disclosure, for controlling access to a traffic network, particularly a network for supporting a large number of users, such as a high density environment of sports stadiums, restaurants and retail venues. The method begins at step 101 when the user enters the venue for the first time. The venue may be a sports stadium having at least one Wi-Fi access point. At step 102, a check is made whether the network access program (app) has been downloaded the smartphone of the user. If the network access program has not been downloaded, to access the Wi-Fi, the user needs to connect to the Wi-Fi network at step 103, by selecting the relevant access point from the smartphone settings. The traffic network access remains locked to most data access at this point as the user is required to first authenticate with the Wi-Fi access point using the app. The access restriction is effected by removing access to all domains except the domains from which a user can download the required application, such as the Play Store and App Store. In particular, a white list of accepted domains which may be accessed by the user is maintained on the controller of the Wi-Fi network. The user then downloads the application but is locked from using the Internet until the app is downloaded and authentication is performed.

When the application has been downloaded and executed on the smartphone, a captive portal page is launched at step 104 and a splash page is presented to the user in the web browser on the smartphone. The splash page contains code, such as Javascript, executable on the smartphone. The splash page needs to collect the information required to redirect the traffic of the user, depending on the operating system of the wireless terminal. For this purpose, the HTTP USER_AGENT field associated with the smartphone is read at step 105 to obtain this information. Depending on the information relating to the operating system at step 106, the user is then presented with the option to download the application from the appropriate store at step 107, such as the Play Store or App Store, or a web page that prompts the user at step 108 for their email if the device is a desktop or unsupported device. Entering the email will unlock the traffic network access at the Wi-Fi access point for the user by submitting an authentication request. This provides a mechanism that allows access to the system for all types of wireless terminals and does not require the user to share personal data (such as personal details, e-mail, home address etc.) thereof to access the Wi-Fi as is often required by prior art access networks.

The application download page is subsequently opened on the store, which may be effected by implementing a link that will open the store with the page containing the relevant application.

Once downloaded, the application will act as a key to authenticate the wireless terminal, such as a smartphone, and allow access to any resource of the traffic network. If the operating system is determined, at step 109, to be Android operating system for example, then the application is launched 110 and will automatically search for an SSID that contains the Wi-Fi access point identifier. The application will connect 113 using a different access method (e.g. another access point or cellular connection) if the relevant Wi-Fi access point is not found at step 112. The application is also configured to time out, after a set period of time searching for a Wi-Fi network, and use another interface for connecting so as not to keep the user waiting for a connection for a prolonged period. The application is also adapted to detect if the user has Wi-Fi interface enabled on their smartphone, for example. If the interface is not enabled, then the application does not proceed to search for the Wi-Fi access point and immediately tries to connect using cellular connection so as not to keep the user waiting for a prolonged period. This relieves the user from having to manually search the network list in the smartphone for the correct access point to join.

Alternatively, if the operating system is determined, at step 109, to be iOS system, then the user connects to the Wi-Fi access point at step 111, via the settings of the smartphone and establishes the unauthenticated link between the smartphone and the Wi-Fi access point. The application is subsequently launched from the splash page at step 114.

At step 115, the application is executed and attempts to access a web page that is not in the white list of allowed domains for the access point. If it can access the web page, then that indicates the link is already authenticated between the wireless terminal, i.e. the smartphone, and the access point. If the web page cannot be accessed, then the splash page is returned to the application. This process happens in the background and is not perceivable by the user. The application subsequently injects Javascript code into the returned splash page, which may automatically authenticate the wireless terminal, via the remote authentication server 60, for example, and unlock access to the traffic network resources at the Wi-Fi access point so that the user can have free access for a configurable period of time, for example 24 hours. The authenticated link will timeout after a configured time and the application will need to be executed again at step 116 to establish a new authenticated link. The benefit to the user is that easy access is given for a set period of time without having to fill out any forms that may prove to be too much of a hindrance.

From the foregoing therefore, it is evident that the method, wireless access point and wireless terminal provide an improved network access infrastructure allowing controlled access to the traffic network resources.

1. A method for controlling access to a traffic network in a high density environment, the traffic network comprising a set of traffic network resources, the method comprising the steps of:
providing at least one wireless access point;
establishing a wireless link between a wireless terminal and the wireless access point;
establishing an unauthenticated traffic link between the wireless terminal and the wireless access point;
restricting access of the wireless terminal to the traffic network via the unauthenticated traffic link to a subset of the set of traffic network resources, wherein at least one traffic network resource is associated with an operating system of the wireless terminal;
detecting the operating system of the wireless terminal using traffic communicated along the wireless link;
establishing a link between the wireless terminal and the traffic network resource associated with the detected operating system;
downloading a traffic network access program to the wireless terminal from the traffic network resource;
executing the traffic network access program on the wireless terminal;
establishing an authenticated traffic link between the wireless terminal and the wireless access point using an authentication signal generated by the network access program.

2. A method according to claim 1, wherein restricting traffic network access includes restricting traffic network access to selected traffic network domains, wherein at least one domain is associated with the operating system of the wireless terminal.

3. A method according to claim 1, the method including a step of sending, from the wireless access point to the wireless terminal, an execution signal adapted to execute the network access program at the wireless terminal.

4. A method according to claim 3, wherein the execution signal is sent from the wireless access point to the wireless terminal via a remote authentication server.

5. A method according to claim 1, wherein establishing an unauthenticated traffic link involves establishing a virtual local area network connection.

6. A method according to claim 1, wherein establishing an authenticated traffic link involves setting a threshold time so that when the time passes the threshold time, the authenticated traffic link becomes closed.

7. A method according to claim 1, further including sending, via the unauthenticated traffic link, a traffic signal to the wireless terminal from the wireless access point, the traffic signal being configured to indicate a location of the network access program in the traffic network resource.

8. A method according to claim 1, wherein the authenticated traffic link between the wireless terminal and the wireless access point is established via a remote authentication server.

9. A wireless access point for controlling access to a traffic network in a high-density environment, the traffic network comprising a set of traffic network resources, the access point comprising:
a module configured to establish a wireless link between a wireless terminal and a wireless access point;
an authentication module configured to establish an unauthenticated traffic link between the wireless terminal and the wireless access point and to restrict access of the wireless terminal to a subset of the set of the traffic network resources, wherein at least one traffic network resource is associated with an operating system of a wireless terminal, the network resource comprising a traffic network access program,
wherein the authentication module is further configured to receive, from the wireless terminal via the unauthenticated traffic link, an authentication signal from the network access program on the wireless terminal, the signal being used to establish an authenticated traffic link between the wireless access point and the wireless terminal.

10. A wireless access point according to claim 9, wherein the authentication module is further configured to send, when the access point uses unauthenticated traffic link, a traffic signal to the wireless terminal, the traffic signal being configured to indicate a (Original) location of the network access program in the traffic network resource.

11. A wireless access point according to claim 9, wherein the access point is a multi-radio wireless access point comprising adaptive antenna array configured to generate a plurality of radio beams so that a number of simultaneous wireless links between the access point and wireless terminals can be maximised.

12. A wireless access point according to claim 9, wherein the authentication module is further configured to restrict traffic network access to selected network domains, wherein at least one network domain is associated with the operating system of the wireless terminal.

13. A wireless access point according to claim 9, wherein the authentication module is further configured to send to the wireless terminal, via the unauthenticated traffic link, an execution signal adapted to execute the network access program at the wireless terminal.

14. A wireless access point according to claim 13, wherein the authentication module is configured to send the execution signal to the wireless terminal via a remote authentication server using the unauthenticated traffic link.

15. A wireless access point according to claim 9, wherein the unauthenticated traffic link comprises a virtual local area network connection.

16. A wireless access point according to claim 9, wherein the authenticated traffic link between the wireless terminal and the wireless access point is established via a remote authentication server.

17. A wireless terminal for accessing a traffic network in a high-density environment, the traffic network comprising a set of traffic network resources, the wireless terminal comprising:
an operating system adapted to execute a network access program;
a first interface for establishing a first wireless link between the wireless terminal and a wireless access point;
a second interface for establishing a second wireless link between the wireless terminal and a beacon;
a traffic link module configured to establish an unauthenticated traffic link between a wireless terminal and the wireless access point, the unauthenticated traffic link having traffic network access restricted to a subset of the wireless terminal traffic network resources, wherein at least one traffic network resource is associated with the operating system of the wireless terminal,
a network access program configured to send an authentication signal to the wireless access point using the traffic link module, the signal being used to establish an authenticated traffic link between the wireless access point and the wireless terminal.

18. A wireless terminal according to claim 17, wherein the unauthenticated traffic link has traffic network access restricted to selected network domains, wherein the at least one domain is associated with the operating system of the wireless terminal.

19. A wireless terminal according to claim 17, wherein the network access program comprises a wireless access point identifier, the network access program being further configured to instruct the first wireless interface to establish a traffic link with the wireless access point identified by the wireless access point identifier.

20. A wireless terminal according to claim 17, wherein the network access program is further configured to receive, via the second interface, location signals from the beacon for navigating the user of the terminal when the terminal is used in a high-density venue.

21. A wireless terminal according to claim 17, wherein the wireless terminal is further configured to receive, from the wireless access point during the unauthenticated traffic link, an execution signal adapted to execute the network access program.

22. A wireless terminal according to claim 21, wherein the wireless terminal is configured to receive the execution signal from the wireless access point via a remote authentication server.

23. A wireless terminal according to claim 17, wherein the wireless terminal is further configured to receive, via the unauthenticated traffic link, a traffic signal from the wireless access point, the traffic signal being configured to indicate a location of the network access program in the traffic network resource.

24. (canceled)

25. (canceled)
